(19) United States
(12) Patent Application Publication
(10) Pub. No.: US 2016/0077691 A1
(43) Pub. Date: Mar. 17, 2016

(54) DATA PROCESSING APPARATUS, DATA PROCESSING METHOD, AND STORAGE MEDIUM

(71) Applicant: CANON KABUSHIKI KAISHA, Tokyo (JP)

(72) Inventor: Mikihiko Kamekawa, Tokyo (JP)

(21) Appl. No.: 14/948,715

(22) Filed: Nov. 23, 2015

Related U.S. Application Data
(63) Continuation of application No. 13/491,012, filed on Jun. 7, 2012.

(30) Foreign Application Priority Data
Jun. 13, 2011 (JP) 2011-130974

(51) Int. Cl. G06F 3/0482; G06F 17/22

(52) U.S. Cl. CPC G06F 3/0482; G06F 17/2241

(57) ABSTRACT

A data processing method of a data processing apparatus includes designating a folder element, an expansion element, and an abbreviation element to be displayed on an address bar. The method further includes generating an abbreviation element that can be used to realize an abbreviation display of an intermediate hierarchy, based on each designated element, and displaying the generated abbreviation element on the address bar. Further, the method includes expanding and displaying hierarchy information including both a folder element and an expansion element that corresponds to the folder element on the address bar.

### CROSS-REFERENCE TO RELATED APPLICATIONS

This application is a continuation, and claims the benefit, of U.S. patent application Ser. No. 13/491,012, presently pending and filed on Jun. 7, 2012, and claims the benefit of, and priority to, Japanese Patent Application No. 2011-130974 filed Jun. 13, 2011, which applications are hereby incorporated by reference herein in their entireties.

### BACKGROUND OF THE INVENTION

1. Field of the Invention

The present invention relates to a data processing apparatus capable of displaying hierarchy information, a data processing method, and a storage medium.

2. Description of the Related Art

In a file system or a document management system that can be used in a data processing apparatus, it is generally known that a hierarchical structure including folders (as conceptual elements) is usable as a method capable of managing files and document information. To enable a user to access a target file (or document) along a path in the hierarchical structure, it is conventionally feasible to display a folder tree (a tree structure) that represents the hierarchical structure in a view area of a display device.

However, if there are many folders belonging to the same hierarchy, the view area may be occupied by these folders at a branched portion of the hierarchical folder tree, and it may be difficult to recognize the path (depth) of the hierarchical folder tree that the user needs to follow to access the target folder.

As discussed in Japanese Patent Application Laid-Open No. 2000-003247, it is conventionally known to provide an independent unit configured to display a hierarchy of a target folder that is actually followed by a user in addition to the folder tree considering the target folder.

However, according to the hierarchy display method discussed in Japanese Patent Application Laid-Open No. 2000-003247, the portion displayed on a screen is substantially limited to a part of the hierarchical structure that relates to the path of the target folder that is actually followed by the user.

Therefore, when the user wants to access another folder belonging to a lower-level hierarchy that is subordinate to an upper-level hierarchy of the current target folder, the user is required to once move to a folder of the upper-level hierarchy and then move to the intended (next target) folder that belongs to the lower-level hierarchy. As a result, the movement between folders requires a complicated operational procedure.

Further, when a user operates on an address bar displayed on a data processing apparatus, if the depth of the hierarchical structure that the user actually follows to access an intended folder is large, it may be difficult to display all of the folders that belong to upper-level hierarchies within the view area of the address bar. Thus, in the movement between two folders that belong to different hierarchies, the user cannot accurately confirm the entire image of an upper-level hierarchy that the user passes to access the intended folder.

The above-described problem is not limited to the system that enables users to search a desired content using a browser of the data processing apparatus. A similar problem may occur in a search system that enables users to search an intended file that is registered beforehand in a database.

### SUMMARY OF THE INVENTION

To solve any one of the above-described problems, the present invention intends to provide a mechanism capable of realizing information display that is excellent in operability in the movement or shift to a upper-level or lower-level folder along a path extending to an intended folder in a hierarchy structure.

According to a first aspect of the present invention, an aspect of the embodiment is a data processing apparatus. The apparatus includes: a display control unit configured to perform display control in such a way as to display, on an address bar, hierarchy information including a folder element that corresponds to a folder belonging to a hierarchy and an expansion element that can be used to expand and display a folder element that corresponds to a folder belonging to a lower-level hierarchy of the folder belonging to the hierarchy; an designation unit configured to designate a folder element or an expansion element displayed on the address bar; and a determination unit configured to determine hierarchy information of an intermediate hierarchy to be subjected to an abbreviation display, of a plurality of pieces of hierarchy information serving as display targets, if a folder element or an expansion element is designated by the designation unit, wherein the display control unit is configured to generate an abbreviation element to perform the abbreviation display of the hierarchy information determined by the determination unit and control the display in such a way as to locate the generated abbreviation element at a position that corresponds to the intermediate hierarchy to be subjected to the abbreviation display, between a plurality of pieces of hierarchy information displayed on the address bar.

According to a second aspect of the present invention, a data processing apparatus includes: a display unit configured to display hierarchy information including a folder element that corresponds to a folder belonging to a hierarchy and an expansion element that can be used to expand and display a folder element that corresponds to a folder belonging to a lower-level hierarchy the folder belonging to the hierarchy, together with an abbreviation element that can be used to realize an abbreviation display of one or a plurality of pieces of the hierarchy information, on an address bar, based on a path extending to a folder selected by a user; an designation unit configured to designate an abbreviation element displayed on the address bar; and an expansion unit configured to expand and display the one or the plurality of pieces of hierarchy information that have been subjected to the abbreviation display using the abbreviation element, on the address bar, if the abbreviation element is designated by the designation unit.

The data processing apparatus according to the present invention can provide an information display that is excellent in operability in the movement or shifting to a upper-level or lower-level folder along a path extending to an intended folder in a hierarchy structure.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example configuration of a data processing apparatus according to an exemplary embodiment of the present invention.

FIG. 2 illustrates a data format of address bar setting information illustrated in FIG. 1.

FIG. 3 illustrates a data format of address bar status information illustrated in FIG. 1.

FIG. 4 illustrates a user interface (UI) that can be displayed by the data processing apparatus.

FIG. 5 illustrates a logical structure of a folder hierarchy that can be used in information management.

FIGS. 6A, 6B, and 6C illustrate display examples of an address bar.

FIG. 7 illustrates a display example of the address bar.

FIG. 8 is a flowchart illustrating example data processing that can be performed by the data processing apparatus according to an exemplary embodiment of the present invention.

FIGS. 9A and 9B illustrate examples of the address bar.

FIG. 10 is a flowchart illustrating example data processing that can be performed by the data processing apparatus according to an exemplary embodiment of the present invention.

FIG. 11 is a flowchart illustrating example data processing that can be performed by the data processing apparatus according to an exemplary embodiment of the present invention.

FIG. 12 illustrates an example of address bar status information that can be used by the data processing apparatus according to an exemplary embodiment of the present invention.

FIG. 13 illustrates an example data format that can be stored as address bar status information.

FIG. 14 is a flowchart illustrating example data processing that can be performed by the data processing apparatus according to an exemplary embodiment of the present invention.

### DESCRIPTION OF THE EMBODIMENTS

Various exemplary embodiments, features, and aspects of the invention will be described in detail below with reference to the drawings.

### <Description of System Configuration>

### <System Screen Configuration>

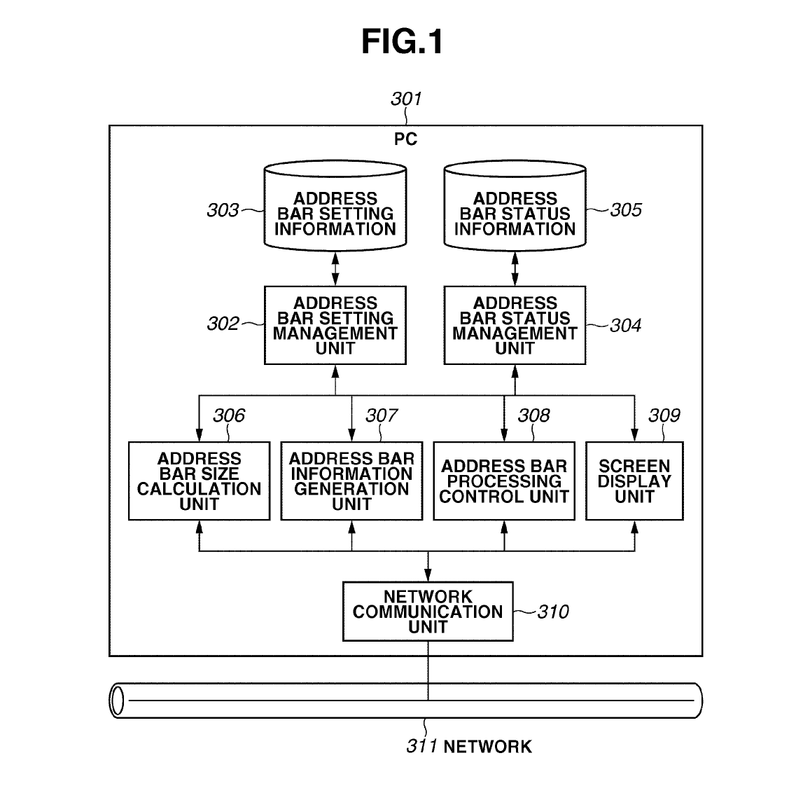

A screen that can display a hierarchical folder structure of a file system and provide a list of files included in the hierarchical structure is described below with reference to FIG. 1.

FIG. 1 is a block diagram illustrating an example configuration of a data processing apparatus according to a first exemplary embodiment. The data processing apparatus illustrated in FIG. 1 is capable of displaying a screen that includes an address bar. In the present exemplary embodiment, the address bar can be displayed as a part of a screen when a content viewer (i.e., a browser) provides the screen on a display device of the data processing apparatus. However, the present invention is applicable to an address bar that is displayed by any software other than the browser.

In the following description, the address bar is a predetermined screen area of the display device in which the data processing apparatus can display hierarchy information. As described below, the present exemplary embodiment provides example processing for expanding and displaying an abbreviated folder element that indicates a target folder that is subjected to abbreviation processing as described below and a folder that belongs to a lower-level hierarchy on the address bar.

Further, the hierarchy information includes the folder element that includes a folder that belongs to a hierarchy and an expansion element that can be used to expand and display a folder element indicating a folder that belongs to a lower-level hierarchy.

The data processing apparatus illustrated in FIG. 1 includes a personal computer (PC) 301, which can be generally constituted by a personal computer and has a hardware configuration that includes a central processing unit (CPU), a random access memory (RAM), a read only memory (ROM), a hard disk drive (HDD), and a network interface card (NIC). Various programs that cause the CPU to execute processing described in each of the following flowcharts are stored in the HDD. The CPU can execute each program, when the program is loaded into the RAM, to operate functionally as each processing unit, such as an address bar setting management unit 302, which executes each functional processing.

Further, the CPU of the PC 301 is electrically connected to an external or built-in display device (hereinafter, referred to as “DIS”), a keyboard (hereinafter, referred to as “KB”), and a pointing device (hereinafter, referred to as “PD”). The CPU can perform input/output control based on an operational instruction from a user. Each user operates the PD to designate an element of the address bar displayed by the display device.

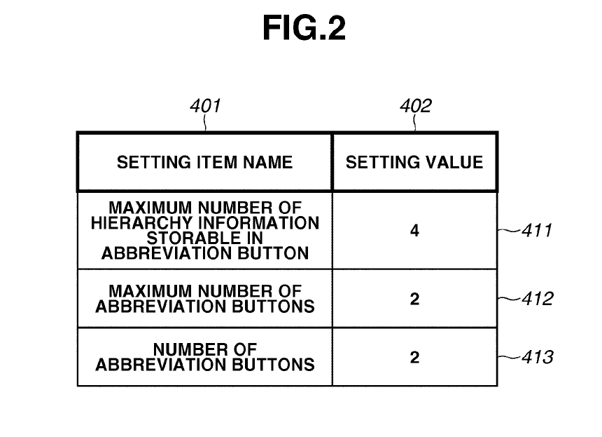

As illustrated in FIG. 1, the PC 301 includes the following processing units that can functionally realize the address bar. First, the address bar setting management unit 302 can input and output address bar setting information 303. The address bar setting information 303 has a data format illustrated in FIG. 2 and can be stored in an area of the RAM or the HDD.

An address bar status management unit 304 can input and output address bar status information 305.

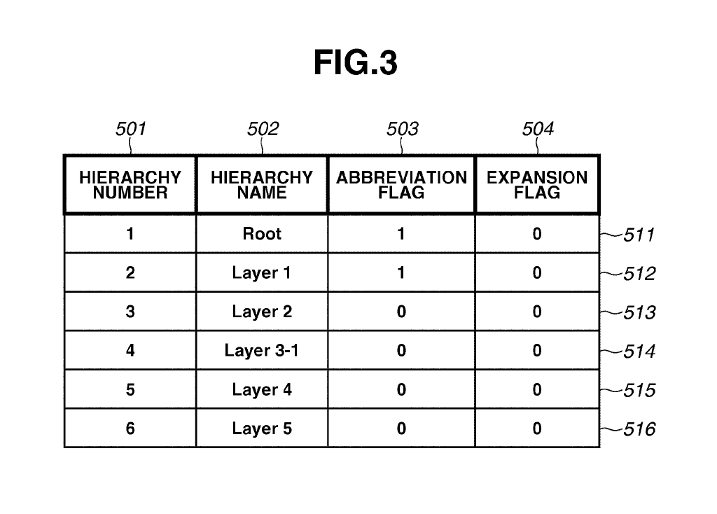

The address bar status information 305 has a data format illustrated in FIG. 3 and can be stored in an area of the RAM or the HDD. The data content of the above-described information can be updated successively in response to a movement between folders when a user operates.

An address bar size calculation unit 306 can perform size information calculation processing to determine whether a display target (e.g., hierarchy information) can be entirely accommodated in the view area of the address bar.

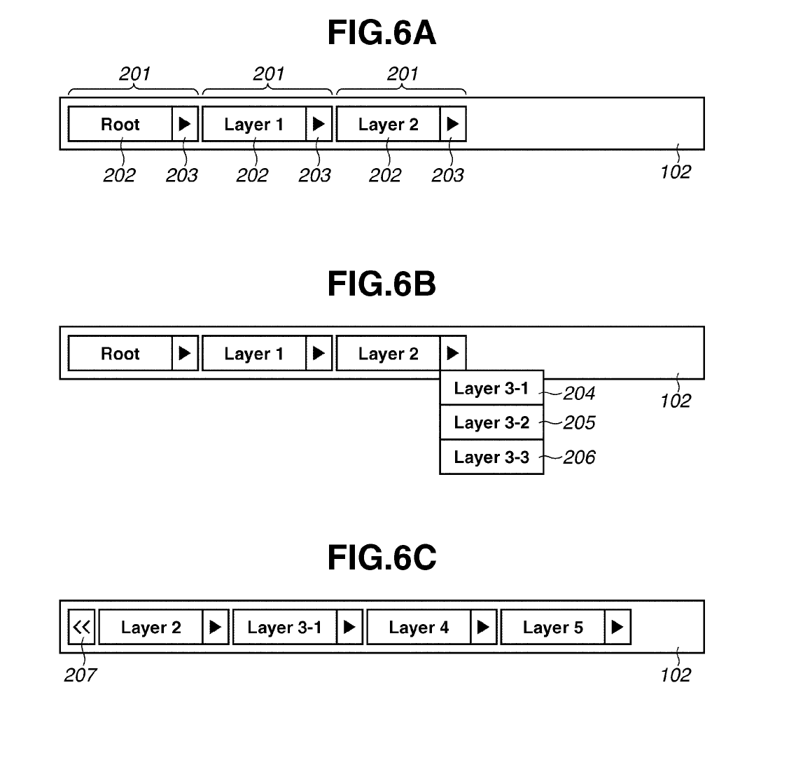

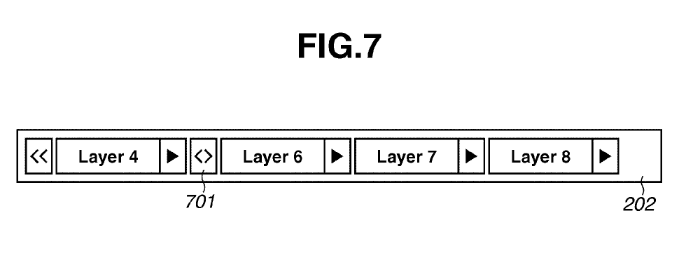

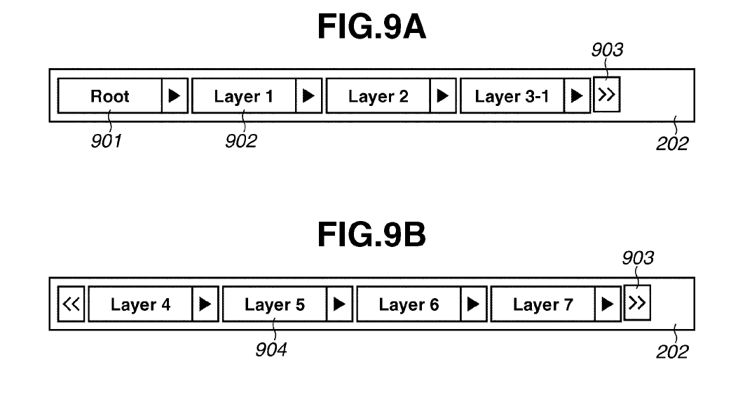

In the present exemplary embodiment, the address bar size calculation unit 306 calculates the width size of the view area of the address bar that is required to display each piece of hierarchy information 201 illustrated in FIG. 6A, an upper-level hierarchy abbreviation button 207 illustrated in FIG. 6C, an intermediate-hierarchy abbreviation button 701 illustrated in FIG. 7, and a lower-level hierarchy abbreviation button 903 illustrated in FIG. 9.

An address bar information generation unit 307 can perform state update processing that is required to display the address bar.

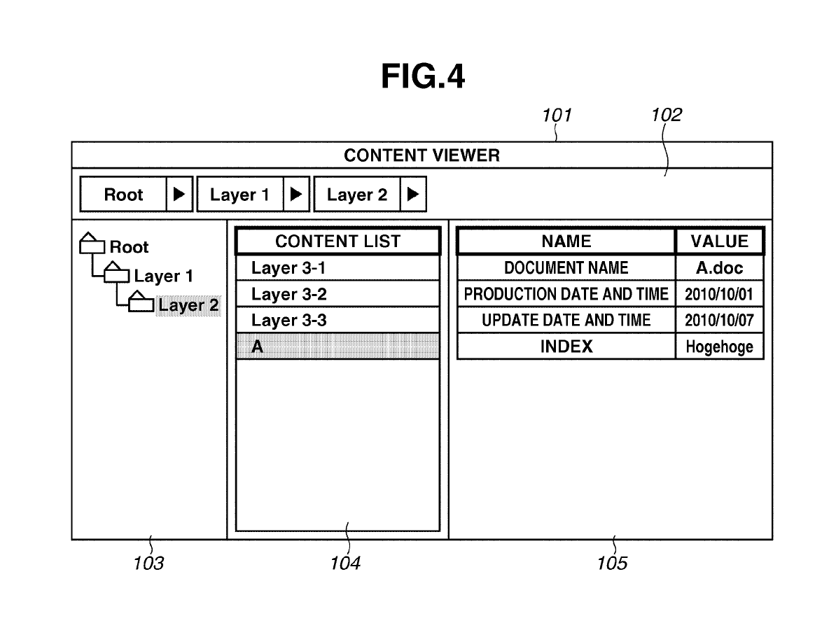

An address bar processing control unit 308 can receive an event if it is caused by a user operation on an address bar 102 or if a state change occurs in other configuration element of a content display screen 101 illustrated in FIG. 4. The address bar processing control unit 308 can determine whether any processing is required for the address bar 102 based on the received event.

The address bar processing control unit 308 generates an instruction that triggers the entire processing for the address bar. Further, if any state change occurs, the address bar processing control unit 308 can request a screen display unit 309 to change the content to be displayed. The screen display unit 309 causes the DIS connected to the PC 301 to display the address bar 102.

The screen display unit 309 is functionally operable to display not only the address bar 102 but also any other configuration element that can be displayed on the DIS. A network communication unit 310 is connected to a network 311 via the NIC. The PC 301 can perform data communications with an external device via the network communication unit 310.

In the present exemplary embodiment, the network communication unit 310 performs communications to acquire information if the information to be displayed on the address bar 102 is present outside the PC 301. The network 311 is a physical network that has the capability of connecting a plurality of devices via the NIC.

### <Data Format and Configuration>

FIG. 2 illustrates a data format of the address bar setting information 303 illustrated in FIG. 1. The address bar setting information 303 illustrated in FIG. 2 includes the vertical data fields of setting item name 401 and setting value 402, which can be referred to when the data processing apparatus performs display control for the address bar 102.

Respective items of the address bar setting information 303 are described in the column of the setting item name 401. Each name in the column of the setting item name 401 can be referred to as key information based on which each setting value can be acquired or set. Numerical values (i.e., setting information) of the above-described respective items are described in the column of the setting value 402.

In the present exemplary embodiment, the address bar setting information 303 includes three setting items (see 411 to 413). The first setting item is the maximum number of hierarchy information storable in abbreviation button 411 that defines the maximum number with respect to the hierarchy information 201 that can be stored in the upper-level hierarchy abbreviation button 207 illustrated in FIG. 6C or the intermediate-hierarchy abbreviation button 701 illustrated in FIG. 7.

The second setting item is the maximum number of abbreviation buttons 412 that defines the maximum number with respect to the abbreviation buttons that can be displayed on the address bar 102. The number of abbreviation buttons 413 indicates the number of abbreviation buttons currently displayed, which is variable when each user operates on the address bar 102.

FIG. 3 illustrates a data format of the address bar status information 305 illustrated in FIG. 1. The table of the address bar status information 305 illustrated in FIG. 3 includes the vertical data fields of hierarchy number 501, hierarchy name 502, abbreviation flag 503, and expansion flag 504. The address bar status information 305 includes hierarchy information to be displayed on the address bar 102.

The information described in one horizontal row (i.e., one record) of the address bar status information 305 is “folder information” that indicates information of one folder. The hierarchy number 501 is information indicating the hierarchy of an address in which a selected folder is stored, which is numbered from the top to the bottom.

The hierarchy name 502 is information that represents a folder name to be displayed, which is tied to the folder represented by the hierarchy number 501. In the present exemplary embodiment, the hierarchy name 502 is the name of each folder that serves as an element representing a hierarchy.

The abbreviation flag 503 is information indicating whether the display of a folder is abbreviated on the address bar 102. The state where the display of a folder is abbreviated is referred to as “abbreviation state.” When the abbreviation flag 503 is “0”, it indicates that the corresponding folder is currently displayed. Further, if the abbreviation flag 503 is another numerical value that is equal to or greater than “1”, it means that the corresponding folder is in the abbreviation state. In this case, each numerical value indicates a group number of the abbreviation button by which the corresponding folder is abbreviated. More specifically, if the abbreviation flag 503 of a folder is changed to a different numerical value, it means that the folder is abbreviated by another abbreviation button.

The expansion flag 504 is information that can be used to hold an expanded state temporarily in the processing for temporarily changing the abbreviated hierarchy display illustrated in FIG. 9A or FIG. 9B. Accordingly, the value of the expansion flag 504 is usually set to “0.” When the hierarchy to be abbreviated is changed, the expansion flag 504 turns into “1 (i.e., expanded state)” or to “0 (non-expanded state).” When the expansion flag 504 is “1”, it means that the display of the folder is abbreviated by an abbreviation button. If the expansion flag 504 is “0”, it means that the folder can be displayed on the address bar.

The table illustrated in FIG. 3 includes horizontal data fields 511 to 516 that store data corresponding to the state of the address bar 102 illustrated in FIG. 6C. From the column describing the hierarchy number 501, it is understood that there are six hierarchies. Each of six hierarchies can be designated as a display target. From the column describing the hierarchy name 502, it is understood that the names of respective hierarchies are “Root”, “Layer 1”, “Layer 2”, “Layer 3-1”, “Layer 4”, and “Layer 5”, which are arrayed from the top to the bottom.

From the column describing the abbreviation flag 503, it is understood that the hierarchy names (see 502) that are currently displayed on the address bar 102 are “Layer 2”, “Layer 3-1”, “Layer 4”, and “Layer 5” of four lower-level hierarchies of the above-described six hierarchies, while the remaining upper-level hierarchies “Root” and “Layer 1” are abbreviated (concealed) together by the upper-level hierarchy abbreviation button 207 of the group “1.”

The above-described plurality of pieces of address bar status information 305 are variable momentarily depending on the size of the view area of the address bar 102 or in response to a user operation.

FIG. 4 illustrates an example user interface (UI) that can be displayed by the data processing apparatus according to the present exemplary embodiment. The screen display unit 309 can display the UI illustrated in FIG. 4 on the DIS. The example illustrated in FIG. 4 is a content display screen 101. The configuration of the content display screen 101 is described in detail below.

The UI illustrated in FIG. 4 includes the address bar 102 that displays address information of a plurality of folders having been operated by a user, as hierarchical path information, from the top to the bottom. The UI illustrated in FIG. 4 includes a folder tree 103 (i.e., a tree structure) representing the entire hierarchical information of the folders having been operated by the user.

In other words, the folder tree 103 illustrated in FIG. 4 can express a hierarchical relationship between a specific folder (e.g., Layer 2) having been operated by a user and other folders including a folder that is not present on the path to the specific folder. The folder currently selected on the folder tree 103 is related to the lowermost layer folder element displayed on the address bar 102. Namely, these two folders represent the same folder “Layer 2.”

A content list 104 displays a list of contents stored in the folder, which is currently selected on the address bar 102 or in the folder tree 103. A property list 105 displays property information relating to the content selected in the above-described content list 104.

Respective blocks (i.e., the address bar 102 through the property list 105) are configured to be related to each other. The present exemplary embodiment relates to an operation of the address bar 102. Hereinafter, the address bar 102 is described in detail below.

### <Hierarchical Structure of Folders>

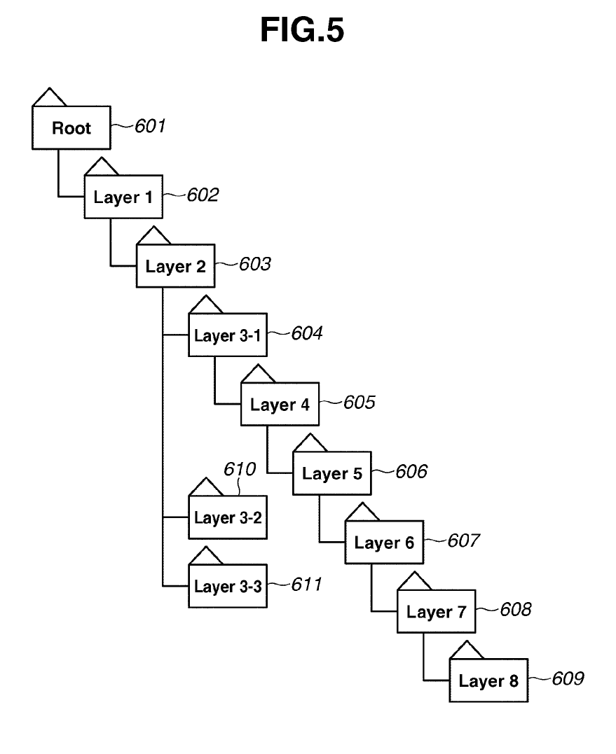

FIG. 5 illustrates a logical structure of folders that can be displayed on the content display screen 101 illustrated in FIG. 4. The folder structure illustrated in FIG. 5 includes a plurality of folders 601 to 611 as configuration elements. Each folder can be linked with an arbitrary number of lower-level hierarchy folders. For example, the folder 601 (named “Root”) is linked with a folder 602 (named “Layer 1”) that belongs to a lower-level hierarchy. Each of the folders 601, 602, and 604 to 608 is linked with a single folder positioned at the lower-level hierarchy thereof.

The folder 603 (named “Layer 2”) is the only one folder that is linked with three lower-level hierarchy folders, i.e., folder 604 (named “Layer 3-1”), folder 610 (named “Layer 3-2”), and folder 611 (named “Layer 3-3”). In the present exemplary embodiment, the following operations are described with reference to the folder structure illustrated in FIG. 5.

### <Address Bar Configuration and Standard Operation>

Hereinafter, the configuration elements that constitute the address bar 102 and standard operations are described with reference to FIG. 6A to FIG. 6C. FIGS. 6A to 6C, FIG. 7, and FIGS. 9A and 9B illustrate various examples of the configuration of the address bar 102 illustrated in FIG. 4.

As illustrated in FIG. 6A, the address bar 102 displays the hierarchical path extending from the folder 601 of the uppermost-level hierarchy (i.e., the folder “Root” illustrated in FIG. 6A) and reaching the folder 603 selected by the user (i.e., the folder “Layer 2” illustrated in FIG. 6A). Therefore, a plurality of (i.e., “three” as illustrated in FIG. 6A) pieces of hierarchy information 201, each representing a hierarchy, is the configuration elements that constitute the address bar 102.

The address bar 102 illustrated in FIG. 6A indicates the presence of two folders “Layer 1” and “Layer 2” that are subordinate to the folder “Root” positioned at the uppermost-level hierarchy. Each piece of hierarchy information 201 is composed of a folder name button 202 and a lower-level expansion button 203. The folder name button 202 includes an area where the hierarchy name 502 of the folder is displayed. The folder name button 202 is functionally operable as a folder element of the hierarchy information 201.

One folder element is associated with one folder. If the user presses the folder name button 202 with the pointing device (PD), the system is brought into a state where the folder that corresponds to the designated folder element is selected. Then, the selected folder is displayed on the address bar 102 as the lowermost-level hierarchy, and the content of the selected folder can be displayed on the content list 104.

For example, if the user operates the PD to press the folder name button 202 of the “Layer 1” on the address bar 102 illustrated in FIG. 6A, the display of “Layer 2” positioned at the lower-level hierarchy thereof disappears and the content of the selected folder is displayed. The lower-level expansion button 203 is usable to display or select a folder that is positioned at a lower-level hierarchy compared to the folder that corresponds to the folder name button 202. In this respect, the lower-level expansion button 203 is functionally operable as an expansion element.

If the user presses the lower-level expansion button 203 of the “Layer 2”, a list box including a plurality of names 204, 205, and 206 that represent lower-level hierarchy folders is displayed as illustrated in FIG. 6B. The user can operate the PD to select one of the names of the lower-level hierarchy folders to access an intended lower-level hierarchy folder. However, in the process of moving to the intended lower-level hierarchy folder, the number of display targets (i.e., the number of the hierarchy information 201) may so increase that all of them cannot be fully displayed within the view area of the address bar.

If the total amount of the hierarchy information 201 exceeds the size of the view area, the upper-level hierarchy abbreviation button 207 is displayed as illustrated in FIG. 6C. The upper-level hierarchy abbreviation button 207 accommodates the non-displayed hierarchy information 201 (i.e., a surplus portion of the hierarchy information 201 that cannot be displayed in the view area) in an abbreviated fashion.

### <Functional Elements Constituting Address Bar>

### <Address Bar Including Two or More Abbreviation Buttons>

The address bar 102 illustrated in FIG. 6C includes the upper-level hierarchy abbreviation button 207 that indicates the presence of non-displayed hierarchy information 201. If the hierarchical depth of the folder that is currently selected by the user becomes larger, the amount of hierarchy information 201 included in the upper-level hierarchy abbreviation button 207 increases. Therefore, when the hierarchical depth of the folder is large, the entire image of the path extending to the intended folder may not be easily recognized based on the display of the address bar 102.

Therefore, if the address bar processing control unit 308 determines that the number of the hierarchy information 201 that belong to the upper-level hierarchy abbreviation button 207 exceeds a setting value defined by the maximum number of hierarchy information storable in abbreviation button 411 included in the address bar setting information 303, the address bar processing control unit 308 provides an additional abbreviation button at an intermediate position of the hierarchy information 201 displayed on the address bar 102.

FIG. 7 illustrates an example of the address bar that can be displayed by the data processing apparatus according to the present exemplary embodiment. The example illustrated in FIG. 7 is an address bar 102 that includes the intermediate-hierarchy abbreviation button 701 positioned (provided) next to the folder “Layer 4” in such a way as to be subordinate to the folder “Layer 4.” From the comparison with the folder structure illustrated in FIG. 5, it is understood that the folder 606 (“Layer 5”) has been abbreviated using the intermediate-hierarchy abbreviation button 701 in the display state illustrated in FIG. 7.

It is feasible to locate one or a plurality of intermediate-hierarchy abbreviation buttons 701 in the address bar. If the address bar setting information 303 illustrated in FIG. 2 includes any setting value with respect to the maximum number of abbreviation buttons 412, the setting value indicates the maximum number of intermediate-hierarchy abbreviation buttons that can be disposed in the address bar.

### <Address Bar Display Processing Flow>

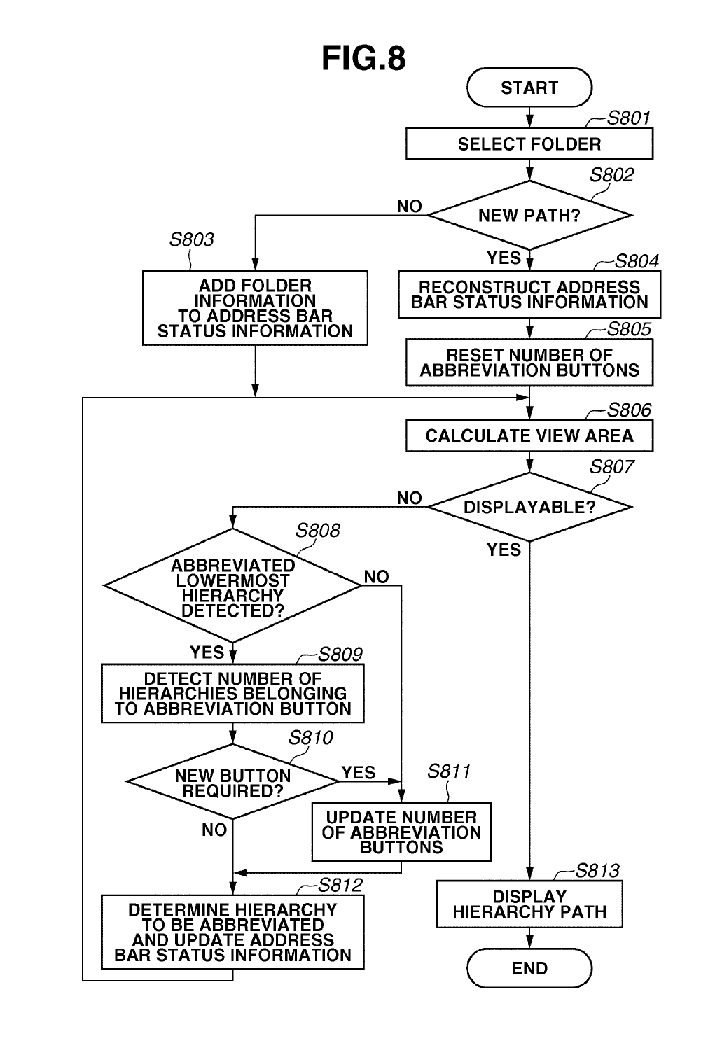

FIG. 8 is a flowchart illustrating example data processing that can be performed by the data processing apparatus according to the present exemplary embodiment. The example processing illustrated in FIG. 8 corresponds to a processing procedure required to display an address bar including the upper-level hierarchy abbreviation button 207 illustrated in FIG. 6C or the intermediate-hierarchy abbreviation button 701 illustrated in FIG. 7.

To realize the processing of each step, the CPU of the PC 301 illustrated in FIG. 1 loads a control program (i.e., a program that is required to execute each processing of the flowchart illustrated in FIG. 8) into the RAM and executes the loaded control program. More specifically, the processing units illustrated in FIG. 1 are mainly used to perform view area (address bar) display processing in response to a user operation using the PD to designate any one of folder elements or expansion elements of the displayed address bar.

The address bar processing control unit 308 starts the processing of the flowchart illustrated in FIG. 8 when a user selects one of the folder name buttons 202 of the address bar 102 or a folder that belongs to the lower-level expansion button 203 on the content display screen 101.

In step S801, the address bar processing control unit 308 acquires the name of a folder selected by a user who operates the PD. Then, the address bar processing control unit 308 stores the acquired folder name in the RAM. Then, the processing proceeds to the next step S802.

Then, in step S802, the address bar processing control unit 308 determines whether the folder name stored in step S801 is the one to be added to the lower-level hierarchy folder in the present address bar status information 305. Namely, the address bar processing control unit 308 determines whether the folder name stored in step S801 is a new path or an additional path. The address bar processing control unit 308 causes the address bar status management unit 304 to acquire all of the address bar status information 305.

Next, the address bar processing control unit 308 generates a folder path based on the hierarchy name 502 of the acquired address bar status information 305 and the folder name acquired in step S801. Then, the address bar processing control unit 308 determines whether the selected folder is present in the file system.

If the address bar processing control unit 308 determines that the folder selected in step S801 is present (NO in step S802), namely, if it is determined that the folder selected by the user is a folder belonging to a lower-level hierarchy (additional path) in relation to the currently concerned folder, the processing proceeds to the next step S803. In this case, the additional path is a path extending to a folder belonging to an immediately subordinate hierarchy from the currently concerned folder (i.e., the folder having the content of a folder displayed on the content list 104).

On the other hand, if the address bar processing control unit 308 determines that the user has selected a new path (an arbitrary folder) other than the additional path (YES in step S802), it is necessary to reconstruct the present address bar status information 305. Therefore, the processing proceeds to step S804.

In this case, the new path is a path extending to an upper-level hierarchy folder from the currently concerned folder or a path extending to a folder abbreviated by the lower-level expansion button 203 displayed on the address bar 102 that corresponds to the upper-level hierarchy folder.

In step S803, the address bar processing control unit 308 causes the address bar status management unit 304 to add folder information of the folder selected by the user to the address bar status information 305. For example, if the folder 607 illustrated in FIG. 5 is selected by the user as the lower-level hierarchy in the state illustrated in FIG. 3, the following information is added to the address bar status information 305.

hierarchy information 501: “7”
hierarchy name 502: “Layer 6”
abbreviation flag 503: “0”
expansion flag 504: “0”
If the address bar processing control unit 308 has completed the above-described folder information addition processing, the processing proceeds to step S806.

On the other hand, when the processing proceeds to step S804 based on the determination that the user has selected a new folder hierarchy (new path), the address bar processing control unit 308 once clears the content of the address bar status information 305 and causes the address bar status management unit 304 to add the hierarchy state extending to the folder designated by the user to the address bar status information 305.

For example, when the folder 610 (“Layer 3-2”) is selected by the user from the folder structure illustrated in FIG. 5 in the state illustrated in FIG. 3, the following four pieces of hierarchy information is added.

For the first hierarchy

hierarchy information 501: “1”

hierarchy name 502: “Root”

abbreviation flag 503: “0”

expansion flag 504: “0”

For the second hierarchy

hierarchy information 501: “2”

hierarchy name 502: “Layer 1”

abbreviation flag 503: “0”

expansion flag 504: “0”

For the third hierarchy

hierarchy information 501: “3”

hierarchy name 502: “Layer 2”

abbreviation flag 503: “0”

expansion flag 504: “0”

For the fourth hierarchy

hierarchy information 501: “4”

hierarchy name 502: “Layer 3-2”

abbreviation flag 503: “0”

expansion flag 504: “0”

In this case, the value “0” (i.e., a numerical value indicating the display state) is set for each hierarchy with respect to the abbreviation flag 503 because the display-ability determination is not yet performed. If the above-described update of the address bar status information 305 has been completed, the processing proceeds to the next step S805.

In step S805, the address bar setting management unit 302 sets the numerical value “0” as the setting value with respect to the number of abbreviation buttons 413 included in the address bar setting information 303 to reset the number of hierarchies being currently abbreviated. If the above-described setting of the address bar setting information 303 has been completed, the processing proceeds to the next step S806.

In step S806, the address bar size calculation unit 306 calculates an area size required to determine whether each piece of hierarchy information 201 is displayable within the present area of the address bar 102 in the state of the configured address bar status information 305.

More specifically, the address bar size calculation unit 306 calculates a horizontal size (width) of the required display with reference to the hierarchy name 502 of each hierarchy that has the value “0” (indicating the display state) as the abbreviation flag 503 of the address bar status information 305.

Then, the address bar size calculation unit 306 adds the horizontal size (width) of the lower-level expansion button 203 to the calculated horizontal size (width) of the required display. The address bar size calculation unit 306 repeats the above-described calculation for each one of a plurality of hierarchies to obtain a summed-up entire size.

Further, the address bar size calculation unit 306 adds the button display size (width) data that correspond to a numerical value representing the number of abbreviation buttons 413 included in the address bar setting information 303.

Then, the address bar size calculation unit 306 temporarily stores the calculation result, as address bar width information, in the RAM of the PC 301. Then, the processing proceeds to the next step S807.

Next, in step S807, the address bar information generation unit 307 compares the display size (width) of the address bar 102 with the address bar width information stored in the RAM in step S806 to determine whether each piece of hierarchy information 201 is displayable in the current situation.

If the address bar information generation unit 307 determines that the display size (width) of the address bar 102 is equal to or greater than the address bar width information (YES in step S807), each piece of hierarchy information 201 is displayable within the present area of the address bar 102. Therefore, the processing proceeds to step S813.

On the other hand, if the address bar information generation unit 307 determines that the address bar width information stored in the RAM exceeds the display size (width) (NO in step S807), it is necessary to perform an abbreviation display for any one of the currently displayed hierarchies. Therefore, the processing proceeds to the next step S808.

Then, in step S808, the address bar information generation unit 307 causes the address bar status management unit 304 to acquire folder information of the abbreviated lowermost-level hierarchy folder (whose abbreviation flag 503 is other than “0”) from the address bar status information 305.

If the address bar information generation unit 307 has acquired the folder information whose abbreviation flag 503 is other than “0” (YES in step S808), it is understood that hierarchy information of an upper-level hierarchy is already in an abbreviation state in relation to the hierarchy information corresponding to the acquired folder information.

Therefore, the address bar information generation unit 307 brings hierarchy information of a lower-level hierarchy into the abbreviation state in relation to the hierarchy information corresponding to the acquired folder information. Then, the address bar information generation unit 307 temporarily stores the acquired folder information in the RAM of the PC 301. Then, the processing proceeds to the next step S809.

Further, if the address bar information generation unit 307 has not acquired the folder information whose abbreviation flag 503 is other than “0” (NO in step S808), the processing proceeds to step S811. In this case, in step S811 and step S812, the address bar processing control unit 308 performs processing required to provide the upper-level hierarchy abbreviation button 207.

Next, in step S809, the address bar information generation unit 307 causes the address bar status management unit 304 to acquire the number of abbreviated hierarchies (i.e., the number of folder information that has a value identical to the abbreviation flag 503 of the folder information acquired in step S808). The address bar information generation unit 307 temporarily stores the acquired number of abbreviated hierarchies in the RAM of the PC 301. Then, the processing proceeds to the next step S810.

Next, in step S810, the address bar information generation unit 307 acquires the setting value with respect to the maximum number of hierarchy information storable in abbreviation button 411 included in the address bar setting information 303 from the address bar setting management unit 302. The address bar information generation unit 307 compares the acquired setting value with the number of abbreviated hierarchies acquired in step S809. If the address bar information generation unit 307 determines that the compared two values are identical to each other, a new abbreviation button is required (YES in step S810). Therefore, the processing proceeds to the next step S811.

On the other hand, if the address bar information generation unit 307 determines that the setting value currently set with respect to the maximum number of hierarchy information storable in abbreviation button 411 is greater than the number of abbreviated hierarchies acquired in step S809 (NO in step S810), it is feasible to newly add an abbreviated hierarchy information to the present abbreviation button. Therefore, the processing proceeds to step S812.

Next, in step S811, the address bar information generation unit 307 causes the address bar setting management unit 302 to acquire the setting value currently set with respect to the number of abbreviation buttons 413 included in the address bar setting information 303. Then, the address bar information generation unit 307 adds “1” to the acquired value, and updates the number of abbreviation buttons 413 with the summed-up value. As a result, the number of abbreviation buttons that can be displayed on the address bar increases. Then, the address bar information generation unit 307 temporarily stores the updated setting value with respect the number of abbreviation buttons 413 in the RAM of the PC 301. Then, the processing proceeds to the next step S812.

Then, in step S812, the address bar information generation unit 307 performs the following processing. More specifically, the address bar information generation unit 307 identifies hierarchy information of an intermediate hierarchy to be subjected to the abbreviation display, among a plurality of pieces of hierarchy information (i.e., a plurality of display targets), and performs processing in such a way as to display hierarchy information of the identified intermediate hierarchy in an abbreviated fashion.

More specifically, the address bar information generation unit 307 determines whether the setting value has been updated with respect to the number of abbreviation buttons 413 in step S811 and whether the folder information has been acquired in step S808. If the setting value has been updated with respect to the number of abbreviation buttons 413 in step S811 and the folder information has been acquired in step S808, the address bar information generation unit 307 causes the address bar status management unit 304 to acquire folder information of the next but one lower-level hierarchy, of the folder information stored in the RAM of the PC 301 in step S808, from the address bar status information 305.

The hierarchy information corresponding to the acquired folder information is an intermediate hierarchy to be subjected to the abbreviation display. Through the above-described processing, the hierarchy information to be subjected to the abbreviation display can be displayed as an abbreviation element positioned between the plurality of pieces of hierarchy information displayed on the address bar.

Then, the address bar information generation unit 307 updates the setting value with respect to the abbreviation flag 503 of the folder information with the setting value stored in the RAM with respect to the number of abbreviation buttons 413 and causes the address bar status management unit 304 to set the address bar status information 305.

Further, if the setting value has been updated with respect to the number of abbreviation buttons 413 in step S811 and the folder information has not been acquired in step S808, the address bar information generation unit 307 causes the address bar status management unit 304 to acquire folder information of the uppermost-level hierarchy (corresponding to the folder information of the folder 601 illustrated in FIG. 5) included in the address bar status information 305.

Then, the address bar information generation unit 307 updates the abbreviation flag 503 of the acquired folder information with the setting value stored in the RAM with respect to the number of abbreviation buttons 413. Further, the address bar information generation unit 307 causes the address bar status management unit 304 to set the address bar status information 305.

On the other hand, if the setting value has not been updated with respect to the number of abbreviation buttons 413 in step S811, the address bar information generation unit 307 causes the address bar status management unit 304 to acquire folder information that is immediately subordinate to the folder information stored in the RAM in step S808 from the address bar status information 305.

Then, the address bar information generation unit 307 updates the abbreviation flag 503 of the folder information with the setting value of the abbreviation flag 503 of the folder information stored in the RAM of the PC 301. The address bar information generation unit 307 causes the address bar status management unit 304 to set the updated address bar status information 305. If the above-described processing has been completed, the processing returns to step S806 to calculate the display-ability again.

Then, in step S813, the address bar processing control unit 308 requests the screen display unit 309 to display an updated address bar based on the abbreviation flag 503 of the address bar status information 305. More specifically, the address bar processing control unit 308 controls the screen display unit 309 in such a way as to display each piece of hierarchy information that corresponds to the numerical value “0” of the abbreviation flag 503 on the address bar 102.

Further, the address bar processing control unit 308 controls the screen display unit 309 in such a way as to display hierarchy information corresponding to the non-“0” value of the abbreviation flag in an abbreviated state using an abbreviation button that corresponds to the value of the abbreviation flag on the address bar 102.

Then, if the address bar processing control unit 308 has thoroughly updated the display content of the screen display unit 309, the address bar processing control unit 308 clears the temporarily used RAM area of the PC 301 and terminates the processing of the flowchart illustrated in FIG. 8.

Thus, the address bar information generation unit 307 can generate each abbreviation button as an abbreviation element that is required to realize the abbreviation display of non-display hierarchy information according to the number of hierarchy information that can be displayed on the address bar. Further, the address bar information generation unit 307 can determine the layout of the generated abbreviation button.

Then, the address bar processing control unit 308 controls the display of each generated abbreviation button and the hierarchy information to be displayed on the address bar according to the position determined by the address bar information generation unit 307. Thus, the address bar processing control unit 308 can perform folder designation considering the entire hierarchy.

### <Expansion of Abbreviated Hierarchy on Address Bar>

FIGS. 9A and 9B illustrate example configurations of the address bar 102 illustrated in FIG. 6. FIG. 9A illustrates an example state of the address bar where abbreviated hierarchy information has been newly displayed when the upper-level hierarchy abbreviation button 207 illustrated in FIG. 6C is pressed. The illustrated example includes hierarchy name buttons 901 and 902 that represent the expanded state of the folder 601 (i.e., “Root”) and the folder 602 (i.e., “Layer 1”), which have been previously concealed in the upper-level hierarchy abbreviation button 207 when subjected to the abbreviation display.

On the other hand, the folder 605 (i.e., “Layer 4”) and the folder 606 (i.e., “Layer 5”) are brought into the non-display state although they are in the expanded state in FIG. 6C. More specifically, both the folder 605 and the folder 606 are included in the lower-level hierarchy abbreviation button 903.

Further, FIG. 9B illustrates an example state of the address bar where abbreviated hierarchy information has been newly displayed when a user operates the PD to press the intermediate-hierarchy abbreviation button 701 illustrated in FIG. 7.

The illustrated example includes a button 904 that represents the expanded state of the folder 606 (i.e., “Layer 5”), which has been previously concealed in the intermediate-hierarchy abbreviation button 701. On the other hand, the folder 609 (i.e., “Layer 8”) is brought into the non-display state although it is in the expanded state in FIG. 7. More specifically, the folder 609 is included in the lower-level hierarchy abbreviation button 903.

### <Abbreviated Hierarchy Expansion Processing Flow>

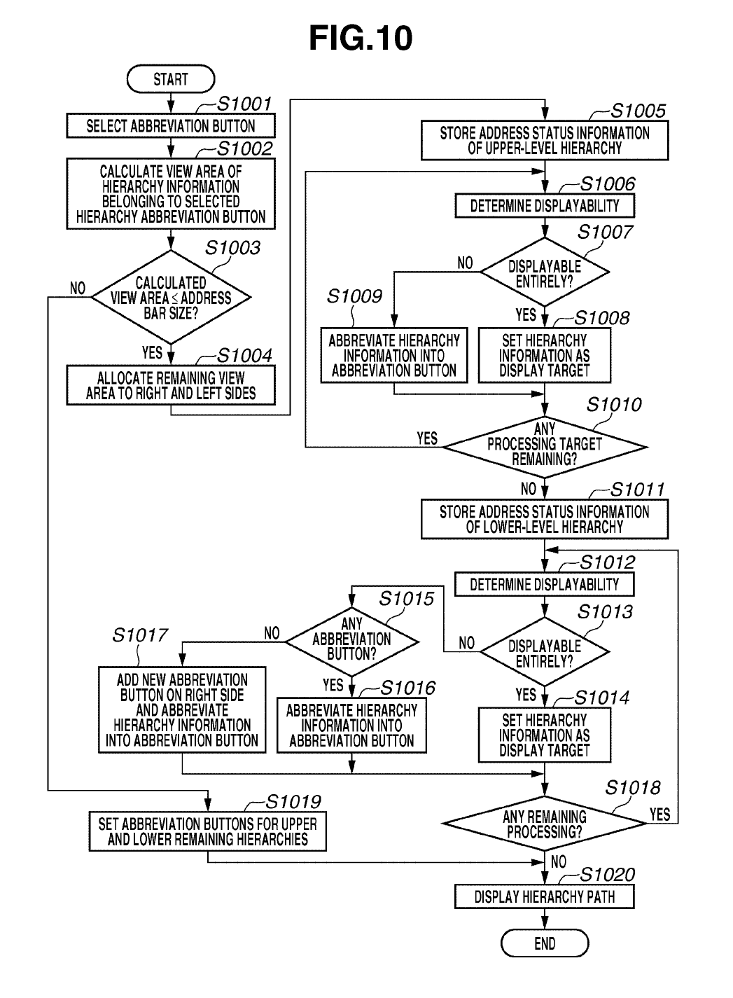

FIG. 10 is a flowchart illustrating example data processing that can be performed by the data processing apparatus according to the present exemplary embodiment. The example processing illustrated in FIG. 10 corresponds to a processing procedure required to perform expansion of abbreviated hierarchy information of the address bar illustrated in FIG. 9A or FIG. 9B. To realize the processing of each step, the CPU of the PC 301 illustrated in FIG. 1 loads a control program required to execute each functional processing into the RAM and executes the loaded control program.

To realize each step of the processing flow, the CPU of the PC 301 illustrated in FIG. 1 loads a control program that is required to execute each processing of the flowchart illustrated in FIG. 10 into the RAM and executes the loaded program. More specifically, the processing of the flowchart illustrated in FIG. 10 can be executed by the processing units illustrated in FIG. 1, such as the address bar processing control unit 308, the address bar information generation unit 307, and the address bar size calculation unit 306.

Further, the address bar processing control unit 308 starts the processing of the flowchart illustrated in FIG. 10 when a user presses the upper-level hierarchy abbreviation button 207 illustrated in FIG. 6C or the intermediate-hierarchy abbreviation button 701 illustrated in FIG. 7.

In step S1001, the address bar processing control unit 308 acquires the positional information of the abbreviation button selected by the user who operates the PD. In this case, the positional information acquired by the address bar processing control unit 308 is a numerical value that represents the position of the abbreviation button numbered in ascending order from the upper-level hierarchy. The address bar processing control unit 308 temporarily stores the acquired numerical value in the RAM of the PC 301. Then, the processing proceeds to the next step S1002.

Next, in step S1002, the address bar size calculation unit 306 acquires hierarchy information that belongs to the abbreviation button having been selected by the user and calculates a view area required when the abbreviated hierarchy is subjected to the expansion processing. More specifically, the address bar size calculation unit 306 acquires the address bar status information 305 that includes the number of abbreviation buttons stored in the RAM of the PC 301 in step S1001 as the abbreviation flag 503, from the address bar status management unit 304.

Next, the address bar size calculation unit 306 calculates a horizontal size (width) that is required to display each acquired hierarchy name 502. Then, the address bar size calculation unit 306 adds the horizontal size (width) of the lower-level expansion button 203 to the calculated horizontal size (width) of the acquired hierarchy name 502. Then, the address bar size calculation unit 306 sums up all of the calculated values.

Further, the address bar size calculation unit 306 sums up the button display size (width) data that correspond to a numerical value representing the maximum number of abbreviation buttons 412 included in the address bar setting information 303. The address bar size calculation unit 306 temporarily stores the above-described calculation result as address bar width information in the RAM of the PC 301.

Finally, the address bar processing control unit 308 causes the address bar status management unit 304 to update the expansion flag 504 of the acquired address bar status information 305 to “0.” Subsequently, the processing proceeds to step S1003.

Next, in step S1003, the address bar information generation unit 307 compares the display size (width) of the address bar 102 with the address bar width information stored in the RAM of the PC 301 in step S1002. If the address bar information generation unit 307 determines that the display size (width) of the address bar 102 is equal to or greater than the stored address bar width information (YES in step S1003), the hierarchy having been subjected to the expansion processing is displayable entirely. Therefore, the processing proceeds to step S1004.

On the other hand, if the address bar information generation unit 307 determines that the address bar width information stored in the RAM of the PC 301 exceeds the display size (width) of the address bar 102 (NO in step S1003), there is not any sufficient view area to display the hierarchy having been subjected to the expansion processing. Therefore, the processing proceeds to step S1019.

Then, in step S1004, the address bar size calculation unit 306 calculates the remaining area of the address bar 102 that is available to display hierarchy information other than the hierarchy information to be expanded. Then, the address bar size calculation unit 306 determines the size of respective blank space areas to be allocated to the right and left sides of the address bar 102.

More specifically, the address bar size calculation unit 306 subtracts the size of the address bar width information stored in the RAM of the PC 301 in step S1002 from the display size (width) of the address bar 102. Further, the address bar size calculation unit 306 divides the subtraction result into halves to be allocated to upper-level and lower-level hierarchies. The address bar size calculation unit 306 stores the divided spaces as an upper-level blank space and a lower-level blank space in the RAM of the PC 301. If the address bar size calculation unit 306 has completed the storage of the upper-level blank space and the lower-level blank space into the RAM of the PC 301, the processing proceeds to the next step S1005.

The address bar processing control unit 308 performs sequential processing in step S1005 to step S1010 to determine the display of hierarchy information that is present in the upper-level hierarchy of the target hierarchy information to be expanded (i.e., the hierarchy information calculated in step S1002). The address bar processing control unit 308 performs the processing in step S1005 to step S1010 repetitively for each of a plurality of target upper-level hierarchies positioned above the target hierarchy information to be expanded until the processing of the final hierarchy (i.e., the uppermost-level hierarchy) is completed.

More specifically, in step S1005, the address bar information generation unit 307 acquires one or more address bar status information 305 whose hierarchy number 501 is smaller than that of the folder information (the address bar status information 305) that corresponds to the hierarchy information of the expansion target acquired in step S1002 from the address bar status management unit 304. Then, the address bar information generation unit 307 temporarily stores the acquired address bar status information 305 of the upper-level hierarchy in the RAM of the PC 301. Then, the processing proceeds to the next step S1006.

Next, in step S1006, the address bar size calculation unit 306 calculates the horizontal size (width) that is required to display the hierarchy name 502 of the address bar status information 305 that belongs to the lowermost-level hierarchy, of all the address bar status information 305 of the upper-level hierarchies acquired in step S1005 and stored in the RAM of the PC 301. Then, the address bar size calculation unit 306 adds the horizontal size (width) of the lower-level expansion button 203 to the calculated horizontal size (width) required to display the hierarchy name 502.

Further, the address bar size calculation unit 306 temporarily stores the calculated display size in the RAM of the PC 301. Then, the processing proceeds to the next step S1007.

In step S1007, the address bar information generation unit 307 compares the display size calculated in step S1006 with the upper-level blank space stored in the RAM of the PC 301 and determines whether the hierarchy name 502 of the immediate upper-level hierarchy can be fully positioned (displayed) in the address bar 102. Further, the address bar information generation unit 307 determines whether the abbreviation flag 503 of the address bar status information 305 is “0.”

If the address bar information generation unit 307 determines that the abbreviation flag 503 is other than “0”, or if the address bar information generation unit 307 determines that the display size is greater than the upper-level blank space stored in the RAM of the PC 301 (NO in step S1007), the hierarchy name 502 of the immediate upper-level hierarchy cannot be fully positioned (displayed) in the address bar 102. Therefore, the processing proceeds to step S1009.

On the other hand, if the address bar information generation unit 307 determines that the abbreviation flag is “0” and the upper-level blank space stored in the RAM of the PC 301 is greater than the display size (YES in step S1007), the processing proceeds to step S1008.

Then, in step S1008, the address bar information generation unit 307 causes the address bar status management unit 304 to update the expansion flag 504 of the target address bar status information 305 to “0” (i.e., the value that corresponds to the display state).

Subsequently, the address bar information generation unit 307 subtracts the display size calculated in step S1006 from the upper-level blank space stored in the RAM of the PC 301. Then, the address bar information generation unit 307 updates the upper-level blank space stored in the RAM of the PC 301 with the obtained (calculated) value. Then, the processing proceeds to step S1010.

On the other hand, in step S1009, the address bar information generation unit 307 causes the address bar status management unit 304 to update the expansion flag 504 of the target address bar status information 305 with the value of the abbreviation flag 503.

More specifically, if the abbreviation flag 503 of the target address bar status information 305 is “0”, the address bar information generation unit 307 updates the expansion flag 504 of the target address bar status information 305 with the value of the abbreviation flag 503 other than “0”, which is the address bar status information 305 positioned above the target. Then, the address bar information generation unit 307 deletes the target address bar status information 305 from the RAM of the PC 301.

Next, in step S1010, the address bar information generation unit 307 determines whether any address bar status information 305 of the upper-level hierarchy to be processed remains in the RAM of the PC 301. If the address bar information generation unit 307 determines that there is not any address bar status information 305 of the upper-level hierarchy to be processed and remaining in the RAM, the address bar information generation unit 307 adds the value of the upper-level blank space stored in the RAM to the lower-level blank space stored in the RAM. Further, the address bar information generation unit 307 updates the lower-level blank space with the added value. Then, the processing proceeds to the next step S1011.

On the other hand, if the address bar information generation unit 307 determines that the address bar status information 305 of the upper-level hierarchy to be processed remains in the RAM of the PC 301 (YES in step S1010), the processing returns to step S1006.

The address bar processing control unit 308 performs sequential processing in step S1011 to step S1018 to determine the display of hierarchy information that is present in the lower-level hierarchy of the target hierarchy information to be expanded (i.e., the hierarchy information calculated in step S1002). The address bar processing control unit 308 performs the processing in step S1011 to step S1018 repetitively for each of a plurality of target lower-level hierarchies positioned closest below the target hierarchy information to be expanded until the processing of the final hierarchy (i.e., the lowermost-level hierarchy) is completed.

More specifically, in step S1011, the address bar information generation unit 307 acquires lower-level address bar status information 305 whose hierarchy number 501 is greater than that of the folder information (the address bar status information 305) that corresponds to the hierarchy information of the expansion target acquired in step S1002 from the address bar status management unit 304. Then, the address bar information generation unit 307 temporarily stores the acquired address bar status information 305 of the lower-level hierarchy in the RAM of the PC 301. Then, the processing proceeds to the next step S1012.

Then, in step S1012, the address bar size calculation unit 306 calculates the horizontal size (width) that is required to display the hierarchy name 502 of the address bar status information 305 that belongs to the uppermost-level hierarchy, of all the address bar status information 305 of the lower-level hierarchies stored in the RAM of the PC 301. Then, the address bar size calculation unit 306 adds the horizontal size (width) of the lower-level expansion button 203 to the calculated horizontal size (width) required to display the hierarchy name 502.

Further, the address bar size calculation unit 306 temporarily stores the calculated display size in the RAM of the PC 301. Then, the processing proceeds to the next step S1013.

In step S1013, the address bar information generation unit 307 compares the display size calculated in step S1012 with the lower-level blank space stored in the RAM of the PC 301 and determines whether the hierarchy name 502 of the immediate lower-level hierarchy can be fully positioned (displayed) in the address bar 102. Further, the address bar information generation unit 307 determines whether the abbreviation flag 503 of the address bar status information 305 calculated in step S1012 is “0.”

If the address bar information generation unit 307 determines that the abbreviation flag 503 is other than “0”, or if the address bar information generation unit 307 determines that the display size is greater than the lower-level blank space stored in the RAM of the PC 301 (NO in step S1013), the hierarchy name 502 of the immediate lower-level hierarchy cannot be fully positioned (displayed) in the address bar 102. Therefore, the processing proceeds to step S1015.

On the other hand, if the address bar information generation unit 307 determines that the abbreviation flag is “0” and the lower-level blank space stored in the RAM of the PC 301 is greater than the display size (YES in step S1013), the processing proceeds to step S1014.

Then, in step S1014, the address bar information generation unit 307 causes the address bar status management unit 304 to update the expansion flag 504 of the target address bar status information 305 to “0” (i.e., the value that corresponds to the display state).

Subsequently, the address bar information generation unit 307 subtracts the display size calculated in step S1012 from the lower-level blank space stored in the RAM of the PC 301. Then, the address bar information generation unit 307 updates the lower-level blank space stored in the RAM of the PC 301 with the obtained (calculated) value. Subsequently, the address bar information generation unit 307 deletes the target address bar status information 305 from the RAM of the PC 301. Then, the processing proceeds to step S1018.

Further, in step S1015, the address bar information generation unit 307 determines whether there is any abbreviation flag 503 whose value is other than “0” in the address bar status information 305 that has the hierarchy number 501 greater than that of the target address bar status information 305. If the address bar information generation unit 307 determines that the abbreviation flag 503 whose value is other than “0” is present, namely, if an abbreviation button is present (YES in step S1015), the processing proceeds to step S1016.

On the other hand, if the address bar information generation unit 307 determines that the abbreviation flag 503 whose value is other than “0” is not present (NO in step S1015), the processing proceeds to step S1017.

When the processing proceeds to step S1016 based on the determination that the abbreviation button is present, the address bar information generation unit 307 causes the address bar status management unit 304 to update the expansion flag 504 of the target address bar status information 305 with the non-“0” value of the abbreviation flag 503 of the address bar status information 305 whose hierarchy number is greater than the target address bar status information 305.

On the other hand, when the processing proceeds to step S1017, the address bar information generation unit 307 causes the address bar status management unit 304 to update the expansion flag 504 of the address bar status information 305 ranging up to that hierarchy with the value of the abbreviation flag 503 found in the above-described step S1015.

More specifically, the address bar information generation unit 307 updates the expansion flag 504 of all the address bar status information 305 belonging to the lower-level hierarchy remaining in the RAM of the PC 301 with a value obtained by adding “1” to the maximum number of abbreviation buttons 412. Then, if the update processing has been completed, the address bar information generation unit 307 deletes all of the address bar status information 305 of the lower-level hierarchy in the RAM. Then, the processing proceeds to step S1018.

Next, in step S1018, the address bar information generation unit 307 determines whether any address bar status information 305 of the lower-level hierarchy to be processed remains in the RAM of the PC 301. If the address bar information generation unit 307 determines that there is not any address bar status information 305 of the lower-level hierarchy to be processed and remaining in the RAM (NO in step S1018), the processing proceeds to step S1020.

On the other hand, if the address bar information generation unit 307 determines that the address bar status information 305 of the lower-level hierarchy remains in the RAM of the PC 301 (YES in step S1018), the processing returns to step S1012.

On the other hand, when the address bar information generation unit 307 determines that the address bar width information stored in the RAM of the PC 301 exceeds the display size (width) of the address bar 102, there is not any sufficient view area to display the expanded hierarchy information 210 (NO in step S1003). Then, the processing proceeds to step S1019.

In step S1019, the address bar information generation unit 307 causes the address bar status management unit 304 to set the numerical value “1” with respect to the expansion flag 504 of each piece of address bar status information 305 positioned at an upper-level hierarchy compared to the expansion target acquired in step S1002.

Further, the address bar information generation unit 307 causes the address bar status management unit 304 to set the numerical value “2” with respect to the expansion flag 504 of each piece of address bar status information 305 positioned at a lower-level hierarchy compared to the expansion target acquired in step S1002.

If the address bar information generation unit 307 has completed the above-described setting of the expansion flag 504, the processing proceeds to step S1020. In this case, the address bar information generation unit 307 adjusts the width of the folder name button 202 in such a manner that each piece of expanded hierarchy information 201 can be fully displayed on the address bar 102.

For example, in a case where three pieces of hierarchy information 201 are expanded, the address bar information generation unit 307 divides the display size (width) acquired by subtracting the display size (width) of each abbreviation button to be displayed on the address bar 102 from the display size (width) of the address bar 102 into three equal parts. Then, the address bar information generation unit 307 performs setting in such a manner that each piece of expanded hierarchy information 201 has a display size (width) comparable to each equal part.

Then, in step S1020, the address bar processing control unit 308 requests the screen display unit 309 to display an updated screen based on the expansion flag 504 of the address bar status information 305. More specifically, the address bar processing control unit 308 controls the screen display unit 309 in such a way as to display each piece of hierarchy information that corresponds to the value “0” of the expansion flag 503 on the address bar 102.

Further, the address bar processing control unit 308 controls the screen display unit 309 in such a way as to realize the abbreviation display of each piece of hierarchy information that corresponds to the non-“0” value of the expansion flag, using abbreviation buttons that correspond to the value of the expansion flag, on the address bar 102.

In response to the request of the address bar processing control unit 308, the screen display unit 309 updates the display content and clears the temporarily used RAM area of the PC 301 and terminates the processing of the flowchart illustrated in FIG. 10.

Thus, by displaying the address bar in the manner described above, the data processing apparatus can provide an appropriate operation procedure that enables each user to move from an arbitrary hierarchy to another hierarchy in the folder hierarchy. Therefore, each user can select a target folder efficiently with a smaller amount of operation along a path extending from the currently displayed hierarchy to the target folder, without shifting to an upper-level or a lower-level hierarchy unnecessarily, while visually confirming the depth of the hierarchical structure of folders.

In the above-described first exemplary embodiment, the data processing apparatus determines the hierarchy information to be abbreviated on the address bar based on the comparison with the maximum number of hierarchy information storable in abbreviation button 411 included in the address bar setting information 303.

A data processing apparatus according to a second exemplary embodiment is different from the data processing apparatus described in the first exemplary embodiment in that the determination of the hierarchy information to be abbreviated on the address bar is dynamically changeable according to the display width of the address bar 102 on the content display screen 101.

Therefore, the following description of the second exemplary embodiment is limited to only the configuration/procedure different from those described in the first exemplary embodiment. The descriptions of the portions similar to those described in the first exemplary embodiment are not repeated.

### <Address Bar Display Processing Flow>

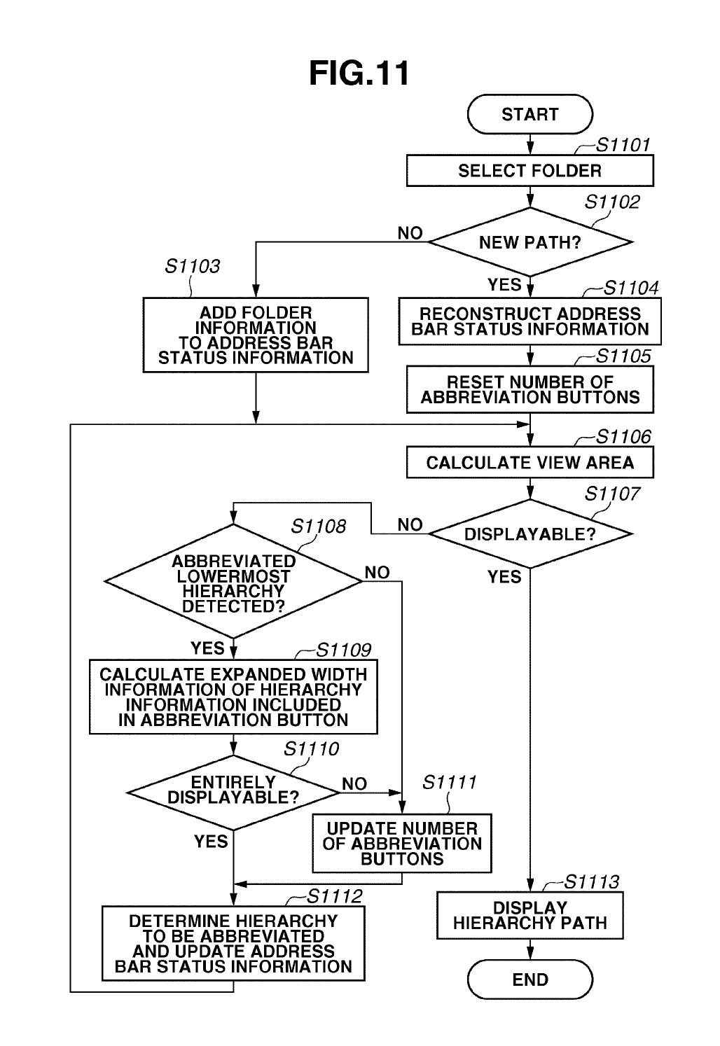

FIG. 11 is a flowchart illustrating example data processing that can be performed by the data processing apparatus according to the present exemplary embodiment. To realize each step of the flowchart illustrated in FIG. 11, the CPU of the PC 301 illustrated in FIG. 1 executes a control program that is required to execute each processing of the flowchart illustrated in FIG. 11 when it is loaded into the RAM.

The example processing illustrated in FIG. 11 corresponds to a processing procedure required to display the address bar including the upper-level hierarchy abbreviation button 207 illustrated in FIG. 6C or the intermediate-hierarchy abbreviation button 701 illustrated in FIG. 7. The address bar processing control unit 308 starts the processing of the flowchart illustrated in FIG. 11 when a user selects an arbitrary hierarchy on the content display screen 101.

The processing flow according to the present exemplary embodiment is different from the processing flow described in the first exemplary embodiment with reference to FIG. 8, in the way of determining whether to abbreviate the hierarchy information to be displayed on the address bar 102. The rest of the processing flow illustrated in FIG. 11 is similar to that described with reference to FIG. 8.

The flowchart illustrated in FIG. 11 includes steps similar to step S801, step S802, step S803, step S804, step S805, step S806, step S807, step S808, step S811, step S812, step S813 illustrated in FIG. 8.

More specifically, step S1101, step S1102, step S1103, step S1104, step S1105, step S1106, step S1107, step S1108, step S1111, step S1112, and step S1113 illustrated in FIG. 11 are similar to the corresponding steps illustrated in FIG. 8 in processing content.

As illustrated in FIG. 11, in step S1109, the address bar size calculation unit 306 calculates a view area required to expand the hierarchy information included in the abbreviation button that is present in the lowermost level.

First, the address bar size calculation unit 306 causes the address bar status management unit 304 to acquire the address bar status information 305 that has a value similar to the abbreviation flag 503 included in the address bar status information 305 acquired in step S1108.

Next, the address bar size calculation unit 306 identifies the largest value with respect to the hierarchy number 501 in the acquired address bar status information 305. The address bar size calculation unit 306 further acquires the address bar status information 305 that has a value greater than the identified value by 1.

Further, the address bar size calculation unit 306 calculates the horizontal size (width) that is required to display the hierarchy name 502 of each address bar status information 305 that has been acquired in this step. Then, the address bar size calculation unit 306 adds the horizontal size (width) of the lower-level expansion button 203 to the calculated horizontal size (width) required to display the hierarchy name 502. Then, the address bar size calculation unit 306 sums up all of the calculated values.

Finally, the address bar size calculation unit 306 sums up the button display size (width) data that correspond to a numerical value representing the number of abbreviation buttons 413 included in the address bar setting information 303. The address bar size calculation unit 306 temporarily stores the summed-up calculation result, as address bar width information, in the RAM. Then, the processing proceeds to the next step S1110.

In step S1110, the address bar information generation unit 307 compares the display size (width) of the address bar 102 with the address bar width information stored in the RAM in the above-described step S1109. If the address bar information generation unit 307 determines that the display size (width) of the address bar 102 is equal to or greater than the address bar width information, it is determined that the target hierarchy is displayable entirely when it is subjected to the expansion processing or even when one hierarchy is added to the abbreviation button (YES in step S1110). Therefore, the processing proceeds to step S1112.

On the other hand, if the address bar information generation unit 307 determines that the address bar width information stored in the RAM exceeds the display size (width) of the address bar 102, it is determined that the target hierarchy cannot be displayed entirely when it is subjected to the expansion processing in a case where one hierarchy is added to the present abbreviation button (NO in step S1110). Therefore, the processing proceeds to step S1111.

As described above, hierarchy information included in the abbreviation button can be displayed on the address bar 102 through the expansion processing. Therefore, the data processing according to the present exemplary embodiment prevents the perspicuity of hierarchy information from deteriorating when the hierarchy information is displayed (expanded) in response to designation on the abbreviation button by a user.

Data processing according to a third exemplary embodiment is different from the data processing described in the first exemplary embodiment in that a group of a plurality of pieces of hierarchy information of the address bar 102 is formed beforehand and the necessity of abbreviation is determined for each group.

Therefore, the following description of the third exemplary embodiment is limited to only the configuration/procedure different from those described in the first exemplary embodiment. The descriptions of the portions similar to those described in the first exemplary embodiment are not repeated.

### <Data Format and Configuration>

The present exemplary embodiment is different from the first and the second exemplary embodiments in the data format of the address bar status information 305.

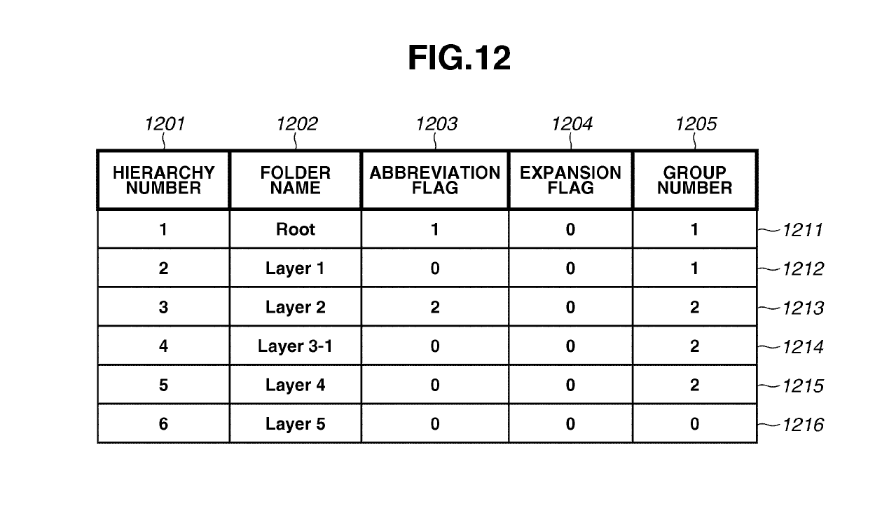

FIG. 12 illustrates an example of the address bar status information that can be used by the data processing apparatus according to the present exemplary embodiment. The table of the address bar status information 305 illustrated in FIG. 12 includes the horizontal data fields of hierarchy number 1201, hierarchy name 1202, abbreviation flag 1203, expansion flag 1204, and group number 1205. The address bar status information 305 includes information corresponding to hierarchy information to be displayed on the address bar 102.

In FIG. 12, the hierarchy number 1201, the hierarchy name 1202, the abbreviation flag 1203, and the expansion flag 1204 are similar to the hierarchy number 501, the hierarchy name 502, the abbreviation flag 503, and the expansion flag 504 illustrated in FIG. 3 in their contents and therefore the descriptions thereof are not repeated. The group number 1205 can be used to perform grouping of hierarchy information to be abbreviated. Every folder, other than the folder that belongs to the lowermost-level hierarchy, has a numerical value that represents the group number.

Only the folder that belongs to the lowermost-level hierarchy is not a target to be grouped with other folder because it is required to display the lowermost-level folder constantly. Therefore, the numerical value “0” is set as the group number of the lowermost-level folder. The table illustrated in FIG. 12 includes the horizontal data fields 1211 to 1216 that store the following information.

There are a total of six hierarchies that can be displayed on the address bar 102. More specifically, the folder names “Root”, “Layer 1”, “Layer 2”, “Layer 3-1”, “Layer 4”, and “Layer 5” are arrayed in this order from the top to the bottom.

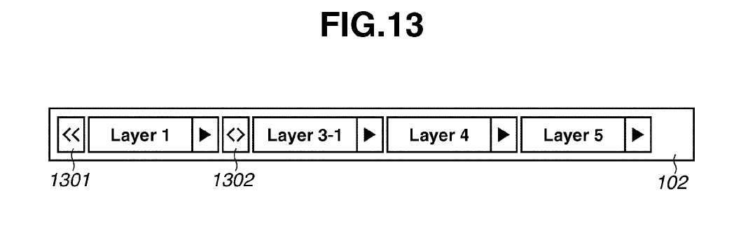

Further, there are two groups. More specifically, the folder “Root” and the folder “Layer 1” belong to group “1.” The folder “Layer 2”, the folder “Layer 3-1”, and the folder “Layer 4” belongs to group “2.” As understood from the illustration of FIG. 13, the folder “Root” (i.e., one of the folders belonging to the group 1) and the folder “Layer 2” (i.e., one of the folders belonging to the group 2) are abbreviated.

### <Configuration of Address Bar>

FIG. 13 illustrates an example data format that can be stored as the address bar status information 305 illustrated in FIG. 1. The data format illustrated in FIG. 13 is different from the examples of the first and second exemplary embodiments described with reference to FIG. 6C and FIG. 7 in that the address bar 102 includes a plurality of abbreviation buttons (i.e., upper-level hierarchy abbreviation button 1301 and intermediate-hierarchy abbreviation button 1302), although the value does not reach the maximum number of hierarchy information storable in abbreviation button 411 included in the address bar setting information 303.

The folder “Root” belongs to the upper-level hierarchy abbreviation button 1301 and the folder “Layer 2” belongs to the intermediate-hierarchy abbreviation button 1302. The above-described grouping is variable momentarily depending on a user operation that designates the depth of selected hierarchies or the size of the view area of the address bar.

### <Address Bar Display Processing Flow>

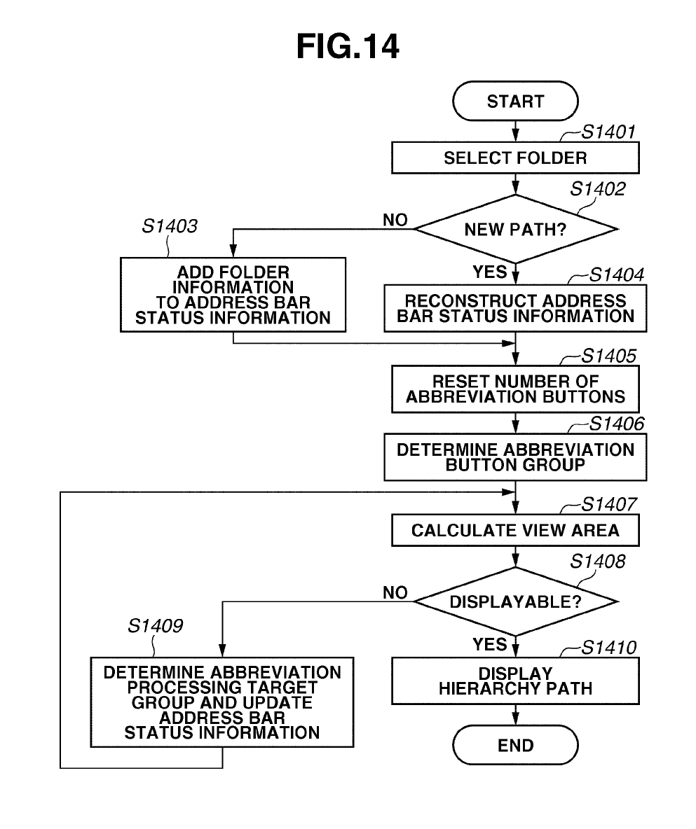

FIG. 14 is a flowchart illustrating example data processing that can be performed by the data processing apparatus according to the present exemplary embodiment of the present invention. The example processing illustrated in FIG. 14 corresponds to a processing procedure required to display the address bar including the upper-level hierarchy abbreviation button 1301 and the intermediate-hierarchy abbreviation button 1302 illustrated in FIG. 13.

To realize the processing of the flowchart illustrated in FIG. 14, a program functionally equivalent to the address bar processing control unit 308, the address bar information generation unit 307, and the address bar size calculation unit 306 illustrated in FIG. 1 is loaded into the RAM of the PC 301 and executed by the CPU of the PC 301. The address bar processing control unit 308 starts the processing of the flowchart illustrated in FIG. 14 when a user selects an arbitrary hierarchy on the content display screen 101.

The processing flow according to the present exemplary embodiment is different from the processing flow described in the first exemplary embodiment with reference to FIG. 8, and different in the procedure of grouping hierarchy information to be abbreviated on the address bar 102, and in the way of determining whether to abbreviate the hierarchy information to be displayed on the address bar 102. The rest of the processing flow illustrated in FIG. 14 is similar to that described with reference to FIG. 8.

Processing to be performed in step S1401, step S1402, step S1407, step S1408, and step S1410 is similar to the processing performed in step S801, step S802, step S806, step S807, and step S813 illustrated in FIG. 8 and therefore the description thereof is not repeated.

As illustrated in FIG. 14, in step S1403, the address bar information generation unit 307 causes the address bar status management unit 304 to add folder information of a folder selected by a user to the address bar status information 305.

For example, if the folder 607 is selected by a user as a lower-level hierarchy on the state illustrated in FIG. 12, the following folder information is added to the address bar status information 305.

hierarchy information 1201: “7”
hierarchy name 1202: “Layer 6”
abbreviation flag 1203: “0”
expansion flag 1204: “0”
group number 1205: “0”
If the addition of the folder information has been completed, the processing proceeds to step S1405.

In step S1404, the address bar information generation unit 307 once clears the content of the address bar status information 305 and causes the address bar status management unit 304 to add the hierarchy state extending to the folder designated by the user to the address bar status information 305.

For example, when the folder 610 (“Layer 3-2”) is selected by the user from the folder structure illustrated in FIG. 5, the following four pieces of hierarchy information can be added.

For the first hierarchy

hierarchy information 1201: “1”

hierarchy name 1202: “Root”

abbreviation flag 1203: “0”

expansion flag 1204: “0”

group number 1205: “0”

For the second hierarchy

hierarchy information 1201: “2”

hierarchy name 1202: “Layer 1”

abbreviation flag 1203: “0”

expansion flag 1204: “0”

group number 1205: “0”

For the third hierarchy

hierarchy information 1201: “3”

hierarchy name 1202: “Layer 2”

abbreviation flag 1203: “0”

expansion flag 1204: “0”

group number 1205: “0”

For the fourth hierarchy

hierarchy information 1201: “4”

hierarchy name 1202: “Layer 3-2”

abbreviation flag 1203: “0”

expansion flag 1204: “0”

group number 1205: “0”

In this case, the address bar information generation unit 307 sets “0” (i.e., a numerical value indicating the display state) for each hierarchy with respect to the abbreviation flag 1203 and the group number 1205, because the display-ability determination is not yet performed.

If the address bar information generation unit 307 has completed the storage of the address bar status information 305, the processing proceeds to the next step S1405. Then, in step S1405, the address bar information generation unit 307 resets the following information.

First, the address bar information generation unit 307 causes the address bar setting management unit 302 to set the numerical value “0” for the number of abbreviation buttons 413 included in the address bar setting information 303 and reset the number of hierarchies being currently abbreviated.

Next, the address bar information generation unit 307 causes the address bar status management unit 304 to set numerical values for the abbreviation flag 1203, the expansion flag 1204, and the group number 1205 included in the address bar status information 305 and reset the abbreviation state. If the setting of the address bar setting information 303 and the address bar status information 305 has been completed, the processing proceeds to the next step S1406.

In step S1406, the address bar information generation unit 307 determines an abbreviation button group to which each piece of hierarchy information belongs. First, the address bar information generation unit 307 causes the address bar status management unit 304 to acquire all of the address bar status information 305 and determines the number of hierarchies to be displayed on the address bar 102. In this case, hierarchy information of the lowermost layer is constantly displayed on the address bar. Therefore, the address bar information generation unit 307 subtracts 1 from the acquired number of hierarchies.

Next, the address bar information generation unit 307 causes the address bar setting management unit 302 to acquire the setting value currently set with respect to the maximum number of abbreviation buttons 412 included in the address bar setting information 303 and divide the acquired value by the above-described number of hierarchies. The integer portion of the value obtained as a division result is the number of hierarchies to be allocated to each group.

The address bar information generation unit 307 allocates the group number to each hierarchy that belongs to the above-described same group, in ascending order of magnitude of the hierarchy number 1201 included in the address bar status information 305.

In this case, the group number begins with the numerical value “1” and increase successively. Further, if the above-described division result includes any remainder in addition to the integer portion, the remainder is allocated to the lowermost layer group. The address bar information generation unit 307 causes the address bar status management unit 304 to set the value allocated to each group as the setting value of the group number 1205 included in the address bar status information 305.

The display example illustrated in FIG. 12 can be calculated in the following manner. There are a total number of six hierarchies. The last hierarchy “Layer 5” is automatically excluded from the grouping processing. Therefore, the number of target hierarchies to be subjected to the grouping processing is “5.” As the setting value currently set with respect to the maximum number of abbreviation buttons 412 is “2”, the number of hierarchies that belong to one group is equal to “2.”

When the above-described grouping is applied to the folders belonging to respective hierarchies from the top to the bottom, two folders “Root” and “Layer 1” belong to the group “1” and two folders “Layer 2” and “Layer 3-1” belong to the group “2.” Further, the folder “Layer 4” belongs to the group 2, because the division result includes the remainder. If the above-described setting for the grouping processing has been completed, the processing proceeds to the next step S1407.

Then, in step S1409, the address bar information generation unit 307 sets one hierarchy as an abbreviation target according to the following logic.

First, the address bar information generation unit 307 causes the address bar status management unit 304 to acquire all of the address bar status information 305, and calculates the number of hierarchies having been already designated as abbreviation targets in each group. The address bar information generation unit 307 determines an abbreviation target group, which is a group that is smallest in the number of hierarchies having been already abbreviated and smallest in the group number 1205.

Next, the address bar information generation unit 307 acquires the address bar status information 305 that is smallest in the hierarchy number 1201, of all the hierarchies not yet being abbreviated, from the address bar status information 305 having the group number 1205 designated as the abbreviation target group.

Then, the address bar information generation unit 307 causes the address bar status management unit 304 to update the abbreviation flag 1203 of the address bar status information 305 with the setting value currently set with respect to the group number 1205. If the address bar information generation unit 307 has completed the update of the abbreviation flag 1203, the processing returns to step S1407.

Next, data processing according to a fourth exemplary embodiment is described below. In addition to each of the above-described exemplary embodiments, it may be desired that the abbreviation display is not applied to a specific folder (e.g., a folder that is large in the number of accesses), for each user, in the above-described display processing, so that the user can easily access to the frequently used folder.

More specifically, a user selects a specific folder from a plurality of folders that are hierarchically associated with the root folder (i.e., the start point of the folder structure) that corresponds to the folder information of the folder 601 illustrated in FIG. 5. It means that the specific folder has been selected based on a user instruction. Then, the address bar processing control unit 308 stores folder information of the selected specific folder as table data and does not designate the selected specific folder as an abbreviation target. More specifically, the values of the abbreviation flag 503 and the expansion flag 504 that corresponds to the specific folder are fixed to “0.”

Next, data processing according to a fifth exemplary embodiment is described below. The data processing includes displaying an expansion element for simultaneously expanding all of the hierarchy information on the address bar, as a full hierarchy expansion element, independent of the abbreviation element. When a user designates the full hierarchy expansion element, the address bar processing control unit 308 performs control for simultaneously displaying hierarchy information corresponding to the abbreviation element.

Further, the address bar processing control unit 308 can be configured to change the number of hierarchies that are storable in the abbreviation element arbitrarily according to a user instruction. Further, the address bar processing control unit 308 can be configured to change the number of displayable abbreviation elements arbitrarily according to a user instruction.

Moreover, the address bar processing control unit 308 can acquire bar width information that can specify the view area of the address bar 102 and control the display of each element with hierarchies whose number is smaller than the number of hierarchies having been set by the user.

Further, in a case where a plurality of abbreviation elements is provided on the address bar, the address bar processing control unit 308 can conceal similar number of hierarchies in each abbreviation element or can dynamically change the total number of abbreviation elements according to the depth of the hierarchy.

A processing apparatus (e.g., CPU or a processor) of a personal computer (or a general computer) can execute a software program acquired via the network or an appropriate storage medium to realize each step of the processing according to the present invention.

The present invention is not limited to the above-described exemplary embodiments and can be modified in various ways (including an organic combination of the above-described exemplary embodiments) based on the spirit or scope of the present invention. The present invention encompasses these modified embodiments.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A data processing apparatus comprising:
a display unit configured to display folder elements and an intermediate-hierarchy abbreviation element on an address bar, wherein the displayed folder elements correspond to a path extending to a folder selected by a user, and wherein the intermediate-hierarchy abbreviation element is displayed between at least one upper-level folder element and at least one lower-level folder element when an abbreviation display of an intermediate folder element between the at least one upper-level folder element and the at least one lower-level folder element is performed;
an expansion unit configured to expand and display, if the intermediate-hierarchy abbreviation element is designated by a user, the intermediate folder element corresponding to the designated intermediate-hierarchy abbreviation element on the address bar; and
a calculation unit configured to calculate upper and lower remaining areas of the address bar that are available to display folder elements other than the expanded intermediate folder element,
wherein the display unit displays an upper-level hierarchy abbreviation element to perform an abbreviation display of upper-level folder elements in relation to the intermediate folder element expanded and displayed on the address bar by the expansion unit if the upper-level folder elements cannot be displayed in the calculated upper remaining area, and
wherein the display unit displays a lower-level hierarchy abbreviation element to perform an abbreviation display of lower-level folder elements in relation to the intermediate folder element expanded and displayed on the address bar by the expansion unit if the lower-level folder elements cannot be displayed in the calculated lower remaining area.

2. A data processing method comprising:
displaying folder elements and an intermediate-hierarchy abbreviation element on an address bar, wherein the displayed folder elements correspond to a path extending to a folder selected by a user, and wherein the intermediate-hierarchy abbreviation element is displayed between at least one upper-level folder element and at least one lower-level folder element when an abbreviation display of an intermediate folder element between the at least one upper-level folder element and the at least one lower-level folder element is performed;
expanding and displaying, if the intermediate-hierarchy abbreviation element is designated by a user, the intermediate folder element corresponding to the designated intermediate-hierarchy abbreviation element on the address bar;
calculating upper and lower remaining areas of the address bar that are available to display folder elements other than the expanded intermediate folder element;
displaying an upper-level hierarchy abbreviation element to perform an abbreviation display of upper-level folder elements in relation to the intermediate folder element expanded and displayed on the address bar if the upper-level folder elements cannot be displayed in the calculated upper remaining area; and
displaying a lower-level hierarchy abbreviation element to perform an abbreviation display of lower-level folder elements in relation to the intermediate folder element expanded and displayed on the address bar if the lower-level folder elements cannot be displayed in the calculated lower remaining area.

3. A computer-readable non-transitory storage medium storing a program that causes a computer to execute a data processing method, the data processing method comprising:
displaying folder elements and an intermediate-hierarchy abbreviation element on an address bar, wherein the displayed folder elements correspond to a path extending to a folder selected by a user, and wherein the intermediate-hierarchy abbreviation element is displayed between at least one upper-level folder element and at least one lower-level folder element when an abbreviation display of an intermediate folder element between the at least one upper-level folder element and the at least one lower-level folder element is performed;
expanding and displaying, if the intermediate-hierarchy abbreviation element is designated by a user, the intermediate folder element corresponding to the designated intermediate-hierarchy abbreviation element on the address bar;
calculating upper and lower remaining areas of the address bar that are available to display folder elements other than the expanded intermediate folder element;
displaying an upper-level hierarchy abbreviation element to perform an abbreviation display of upper-level folder elements in relation to the intermediate folder element expanded and displayed on the address bar if the upper-level folder elements cannot be displayed in the calculated upper remaining area; and
displaying a lower-level hierarchy abbreviation element to perform an abbreviation display of lower-level folder elements in relation to the intermediate folder element expanded and displayed on the address bar if the lower-level folder elements cannot be displayed in the calculated lower remaining area.
